(19) United States
(12) Patent Application Publication
(10) Pub. No.: US 2016/0016805 A1
(43) Pub. Date: Jan. 21, 2016

(54) METHOD FOR PRODUCING SYNTHETIC DIAMONDS

(71) Applicant: CAMBRIDGE ENTERPRISE LIMITED, Cambridge, Cambridgeshire (GB)

(72) Inventors: Derek John FRAY, Cambridge (GB); Carsten SCHWANDT, Cambridge (GB); Ali Reza KAMALI, Cambridge (GB)

(21) Appl. No.: 14/649,367

(22) PCT Filed: Dec. 4, 2013
(86) PCT No.: PCT/EP2013/075585

§ 371 Date: Jun. 3, 2015

(30) Foreign Application Priority Data
Dec. 5, 2012 (GB) 1221899.6
Jan. 24, 2013 (GB) 1301299.2

(51) Int. Cl. C01B 31/06

(52) U.S. Cl. CPC C01B 31/06

(57) ABSTRACT

A method of producing diamonds comprises the steps of providing a nano-structured carbonaceous material, and thermally treating the nano-structured carbonaceous material in an oxygen-containing environment so as to produce diamonds. The nano-structured carbonaceous material may be materials such as carbon nano-particles, carbon nano-tubes and carbon nano-scrolls. It is preferred that the nano-structured carbonaceous material is created by electrochemical erosion of graphite. Thermal treatment to form the diamonds may occur in a temperature window within which the nano-structured carbonaceous material oxidises but diamond crystals are relatively more stable.

The present invention relates to a method of producing diamonds from graphite. In one embodiment, the graphite may be eroded electrochemically in a molten salt, and the carbon nanostructures resulting from this electrochemical erosion may be heat treated in air at ambient pressure to produce synthetic diamonds.

### BACKGROUND

Diamond is one of the best characterised allotropes of carbon. It possesses a unique combination of materials properties including the highest known hardness, excellent thermal conductivity, high chemical inertness, good biocompatibility, and a wide optical transmission range. Owing to its extreme hardness, diamond is widely applied in tools as cutting and wear-resistant material. Diamond is also used as an anti-erosion agent in the oil and other industries, as a polishing material in the optics and electronics sector, and has been proposed as a lubricant in vacuum tribology.

Other applications of diamond include its use as a transmission window for lasers, sensing and imaging and heat-spreaders for optoelectronic and semiconductor devices, in electrochemical devices such as electrical double layer capacitors, in micro-electromechanical systems (MEMS), as a medical implant material, as a carrier component in drug delivery systems, and in the nuclear field.

Diamond can also be applied to improve the properties of advanced composites, due to its high hardness and thermal conductivity and/or its low thermal expansion coefficient. For example, the incorporation of nanodiamond powder into organic polymers such as polyvinyl alcohol, polylactide and epoxy leads to improved mechanical properties and thermal conductivity in the composites. Moreover, composites of diamond/Al, diamond/SiC/AI, diamond/Cu, diamond/carbon nanotube and diamond/pyrocarbon are useful in applications such as field emission devices, electronic packaging and heat sinks.

The transformation of graphite into diamond is of great interest to academia and industry and has been the subject of numerous studies for many decades. The phase diagram of carbon shows that diamond is the thermodynamically stable allotrope of carbon at pressures in excess of several GPa in a wide temperature range. However, diamond may also exist as a metastable phase at ambient pressure.

It is possible to convert graphite directly into diamond, but this requires extreme pressures and temperatures to overcome the large activation energy that is necessary for the breaking of the sp²-bonds in the graphite structure and the formation of new sp^{a}-bonds in the diamond structure.

In the 1950s, it was discovered that molten transition metals such as Fe, Co, Ni and their alloys are able to dissolve carbon and then precipitate diamond under the conditions of high pressure and high temperature (HPHT) in its thermodynamically stable region. Typical pressures required are 5 to 6 GPa at temperatures of at least 1300° C. In this process, the metallic medium acts as a solvent-catalyst that reduces the activation energy, and thereby the pressure-temperature conditions, for the graphite-to-diamond transition.

Diamond may be produced at low pressures by means of a chemical vapour deposition (CVD) process. CVD processes deposit diamonds on a substrate using a heated mixture of carbon-containing gas and hydrogen. Gem quality synthetic diamonds have been produced by using diamond seed crystals and a CVD process.

In the 1990s, it was demonstrated that the molten carbonates of Li, Na, K, Cs, Mg, Ca and Sr are also able to act as a solvent-catalyst for diamond formation from graphite at typical HPHT conditions of 5 to 8 GPa and 1600 to 2150° C. Subsequently, several other inorganic melts, including alkali metal halides such as LiCl and mixed systems comprising more than one component, have been used successfully under similar experimental conditions. In all cases, applying HPHT conditions has been considered as a critical prerequisite for the successful transformation.

### SUMMARY OF INVENTION

The present invention provides a method of producing diamonds and a powder comprising diamonds as defined in the appended independent claims, to which reference should now be made. Preferred or advantageous features of the invention are set out in various dependent sub-claims. The invention also provides diamonds produced by the defined method.

The method may provide that nano-structured carbonaceous material (carbonaceous nanostructures), such as nanotubes and nanoparticles, are heated in an oxidising atmosphere. For example, a first aspect may provide a method of producing diamonds comprising the steps of providing a nano-structured carbonaceous material, and thermally treating the nano-structured carbonaceous material in an oxygen-containing environment so as to produce diamonds. The oxygen-containing environment is a gaseous environment comprising oxygen molecules in gaseous form. Thermal treatment may involve steps of heating the carbonaceous material to a temperature greater than ambient temperature, and sufficient to initiate diamond formation, and cooling to ambient temperature.

The diamonds produced are preferably diamond crystals having a diameter of between 0.05 micrometres (pm) and 100 micrometres, for example between 0.1 micrometres and 20 micrometres, or 0.5 micrometres and 15 micrometres, for example between 1 micrometer and 10 micrometres, or about 1 micrometres. The diamonds may have a diameter of between 0.05 micrometres and 5 micrometres, or 0.05 micrometres and 1 micrometre, or 0.05 micrometres and 0.5 micrometres. The diamonds produced may have a diameter of the order of 15 micrometres or 20 micrometres, or 25 micrometres. Diamonds may be formed having a diameter extending to more than 100 micrometres.

Advantageously, diamonds produced by a method defined herein tend to have a regular crystal shape. For example, a substantial proportion of the diamonds formed may have a regular octahedral shape. A substantial proportion may be greater than 50% of the diamonds formed, or greater than 60%, or greater than 75%, or greater than 85%, or greater than 90%.

Preferably a specified proportion of the diamond crystals formed have a diameter that falls within a specified size range. The specified proportion may be, for example, greater than 50%, or greater than 60%, or greater than 75%, or greater than 85%, or greater than 90%. The specified size range may be for example between 0.05 micrometres and 100 micrometres, for example between 0.1 micrometres and 20 micrometres, or 0.5 micrometres and 15 micrometres, for example between 1 micrometer and 10 micrometres, or about 1 micrometres. The specified size range may be between 0.05 micrometres and 5 micrometres, or 0.05 micrometres and 1 micrometre, or 0.05 micrometres and 0.5 micrometres.

The term “nano-structured carbonaceous material” relates to material in the form of one or more carbon-based nano-structures. The material may be, for example, in the form of a powder comprising one or more carbon-based nanostructures such as nano-particles, nano-tubes, nano-scrolls, nano-filaments, and nano-onions. Structures such as nano-particles, nano-tubes, and nano-scrolls may be single-walled or multi-walled. Nano-structured carbonaceous material may relate to any fullerene-based carbon particles. Nano-structured carbonaceous material may relate to any nano-scale graphene-based particles.

The physical size of individual elements of a nano-structured carbon material will be understood by those in the art. For example, nano-tubes typically have a diameter of between 2 nm and 100 nm. The length of these structures may be many hundreds or thousands of times the diameter. For example, despite their nanoscale diameter, individual nano-tubes may have lengths exceeding 1 micrometre, or greater than 10 micrometres. As the diameter of nanotubes is of the order of 2 nm to 100 nm, it is notable that diamonds produced may have a size that is significantly greater than the size of the nanostructures from which they are formed. The diamonds may form by a process of initiation, or nucleation, followed by growth. The ultimate size of the diamonds may be controlled by controlling initiation and growth parameters.

Nano-structured carbonaceous material may frequently be in the form of a three-dimensional structure formed from single layers of carbon atoms (graphene). Thus, the graphene layer may define the shape of the nano-structure, and the internal portion of the nano-structure may be a void. Thus, nano-tubes and nano-scrolls are hollow structures formed by one or more graphene layers. The skilled person will be aware of various carbon species that may form part of a nano-structured carbonaceous material.

Graphene consists of interconnected hexagons of carbon atoms which are bonded to each other via sp² bonds, whilst diamond is a three-dimensional network of sp³-hybridized carbon atoms. Although nano-structured carbonaceous material is mainly made of sp²-bonded carbon atoms, the out-of-plane curvature of carbon sheets, as well as pentagon-heptagon pair defects present in this material, result in partial sp³ hybridization. Therefore, it may be the case that nano-structured carbon material such as carbon nanotubes and particles comprises a relatively high proportion of sp³ bonds in addition to the normal sp² bonds of graphite.

Carbon sp³ bonds may act as nucleation sites for diamonds. During thermal treatment, diamonds may nucleate and grow at the sites of sp³ bonds within the nano-structured carbon material.

It may be preferred that the nano-structured carbonaceous material is in contact with a suitable catalyst or catalytic reagent when thermally treated. For example, it may be preferred that at least a portion of the carbonaceous material is in contact with a catalyst or reagent that lowers the activation energy required to break sp² bonds associated with a graphite structure and form sp³ bonds associated with nucleation of diamond.

It may be preferred that at least a portion of the carbonaceous material is in contact with a catalyst or reagent that lowers the oxidation temperature of the nano-structured carbon material during thermal treatment.

As used herein, the term “catalyst” means a reagent that lowers the activation energy of a chemical reaction or increases the rate of a chemical reaction. The term includes true catalysts, which are not consumed during the chemical reaction, and consumable catalytic reagents, which are consumed during the chemical reaction.

Suitable catalysts may comprise one or more alkali metal. For example, a catalyst may comprise lithium, or sodium, or potassium. A catalyst may conveniently be in the form of an alkali metal salt.

A preferred catalyst may be in the form of an alkali metal carbonate. Alkali metal carbonates may act as consumable catalytic reagents that lower the oxidation temperature of carbonaceous compounds. A process where the oxidation temperature of carbonaceous material is lowered by use of an alkali metal carbonate may be termed catalytic oxidation.

A catalyst may be, or may comprise, lithium carbonate or sodium carbonate. The carbonaceous nanostructures may contain nanoscale salt particles. The salt particles may be lithium or sodium salt particles. It may be preferred that the nanostructures contain nanoscale particles of lithium carbonate. Nanoscale salt particles may have dimensions of between 1 and 10 nanometres.

A catalyst may preferably be formed on, or deposited onto, surfaces of the nano-structured carbonaceous material. It may be particularly preferred that at least a portion of catalyst is disposed within the nano-structured carbonaceous material. For examples, carbon nano-structured species such as nano-tubes and nano-scrolls have an internal cavity. It may be advantageous for a portion of catalyst to be disposed within the internal cavity of a nano-structured carbonaceous species, for example in contact with an internal wall of a nano-structured carbonaceous species.

A catalyst may be preferably in the form of nano-spots or nano-particles of catalyst. For example, a catalyst disposed in contact with an inner surface of a carbon nano-tube may preferably have a diameter of between 1 and 10 nanometres and a volume of between 1 nm³ and 100 nm³.

A catalyst may be added to the nano-structured carbonaceous material prior to or during the step of thermally treating the material. For example, a powder comprising nano-structured carbonaceous material such as carbon nano-tubes may be washed with a solution containing a catalyst, such as lithium carbonate. The lithium carbonate may then deposit onto the carbonaceous material to act as a catalyst during subsequent thermal treatment.

It may be particularly preferable that a catalyst is incorporated into the nano-structured carbonaceous material during the formation of the nano-structured carbonaceous material. This may negate the need for an additional step to add catalyst to nano-structured carbonaceous material. This may also advantageously allow the formation of catalyst particles within nanostructures such as nano-tubes, nano-scrolls, and nano-particles.

It may be preferred that the nano-structured carbonaceous material is formed, at least in part, by electrochemical erosion of graphite in a molten salt. Such material may be termed electrochemically-produced carbon material (EPC). Preferably the molten salt is a lithium bearing salt or a sodium bearing salt. It may be particularly preferred that carbonaceous material is formed at a temperature of between 650° and 1200° C., and that the nano-structured carbonaceous material is created by the intercalation of lithium or sodium into graphite. It may also be preferred to create the carbonaceous material using geometric cathodic densities between 0.5 and 3 A cm⁻². Control of the temperature of formation and the cathodic densities may allow an operator of the process to control the proportion and dimensions of different nano-structures within the nano-structured carbonaceous material. The use of lithium or sodium may allow the formation of lithium carbonate or sodium carbonate within the nano-structures during formation of the nano-structures.

The process of electro-chemical erosion of graphite may advantageously increase the proportion of sp³ bonds in the resulting nanostructures in comparison with nanostructures produced by other means. For example, an alkali metal such as lithium may act as a catalyst for conversion of sp² bonds to sp³ bonds, and the intercalation of lithium into a graphite structure may, thus, form nano-structures that have a relatively high proportion of sp³ bonds. As stated above, sp³ bonds may promote nucleation and subsequent growth of diamonds during thermal treatment.

Preferably, the nanostructures are thermally treated in an oxygen-containing environment containing at least 0.1 volume % oxygen, for example at least 1 volume % oxygen. The environment surrounding the nano-structured carbonaceous material may comprise an inert gas with at least 0.1 volume % or at least 1 volume % oxygen, or may comprise a partial vacuum and at least 0.1 volume % or at least 1 volume % oxygen. It is particularly advantageous that the thermal treatment may be carried out in air.

The step of thermally treating the nano-structured carbonaceous material is preferably carried out at a pressure lower than 1000 kPa. The use of a low pressure for the thermal treatment advantageously removes the need for the thermal treatment to be carried out using expensive equipment designed to operate at high pressures. It is particularly preferable that the thermal treatment is carried out at a pressure lower than 200 kPa, for example at about 100 kPa.

It may be particularly advantageous that the carbonaceous material is thermally treated at ambient pressure, for example under atmospheric pressure. Thus, there is no need for the method to be carried out in a pressurised apparatus.

Thermal treatment of the nano-structured carbonaceous material preferably takes the form of heating the carbonaceous material, or the environment surrounding the carbonaceous material, to a predetermined temperature and then cooling the material to ambient temperature. It is preferred that the nano-structured carbonaceous material is heated to a temperature at which the material starts to oxidise. This temperature may depend on the composition of the environment surrounding the carbonaceous material. For example, if the environment surrounding the carbonaceous material has greater than 10 volume % oxygen, for example if the environment is air, then the maximum temperature of the environment surrounding the carbonaceous material may be limited to between 400° C. and 700° C., for example between 400° C. and 550° C., or between 440° C. and 535° C., or between 450° C. and 550° C., or between 500° C. and 650° C.

If the environment surrounding the carbonaceous material has lower than 10 volume % oxygen, then the maximum temperature of the environment surrounding the carbonaceous material may be limited to between 400 and 1300° C., for example between 500 and 1000° C. Thus, the atmosphere surrounding the nanostructures may be controlled to influence the temperature at which oxidation occurs.

Advantageously, in preferred embodiments the nano-structured carbonaceous material may be thermally treated by heating at ambient pressure in air to form the diamonds.

Heating may be carried out by ramping the temperature to a desired maximum temperature. For example nano-structured carbonaceous material may be heated to a target temperature of between 400 and 700° C. at a rate of between 1 and 150° C. per minute. Preferred heating rates may be between 50° C. or 60° C. per minute and 120° C. per minute, for example between 80° C. per minute and 100° C. per minute, or about 80° C. per minute. The preferred heating rates may be lower, particularly where large thermal masses are involved. For example, heating rates may be between 5° C. and 50° C. , for example between 10° C. and 25° C.

Once the nano-structured carbonaceous material has reached the target temperature it may be cooled immediately. Alternatively, the nano-structured carbonaceous material may be held at a predetermined temperature at which oxidation occurs for a period of time before being cooled. It may be difficult to determine the precise temperature of the nano-structured carbonaceous material. Thus, the nano-structured carbonaceous material may be held in an environment maintained a predetermined temperature at which oxidation of the nano-structured carbonaceous material occurs. The nano-structured carbonaceous material may be held in this environment for a period of time before being cooled.

The nano-structured carbonaceous material may be heated by placing the material into an environment that has been pre-heated to a predetermined temperature, for example a temperature of between 400 and 1350° C., for example between 400 and 700° C. if the environment is air. Thus, the thermal treatment may occur without ramping the temperature.

It is preferable that heating of the nano-structured carbonaceous material is carried out until the onset of oxidation of the carbonaceous nanostructures. Suitable conditions (i.e. atmosphere, maximum temperature and heating rate) to cause oxidation may be determined in advance, for example using Differential Scanning calorimetry (DSC). Thermal treatment of the carbonaceous material to form diamonds may be carried, on a small scale, out in a DSC apparatus. On a commercial scale an apparatus that replicates the functions of a DSC apparatus may be constructed to thermally treat many kilograms, or hundreds of kilograms of nano-structured carbonaceous material at a time.

It is preferable that the carbonaceous material is not held at the maximum desired temperature for too long. It may be preferred that the material is not held at a predetermined maximum temperature for longer than a period of 10 minutes before being cooled. For example, when thermally treated in an atmosphere of air it is preferred that the carbonaceous material is held at a temperature of between 400 and 700° C. for less than 10 minutes, preferably less than 8 minutes or less than 7 minutes. This reduces the material that is lost due to oxidation.

It may be preferred that the carbonaceous material is allowed to undergo oxidation for a predetermined period of time before being cooled. For example, the material may be cooled at a period between 5 seconds and 10 minutes after the onset of oxidation. Preferably the material may be cooled between 10 seconds and 60 seconds after the onset of oxidation, for example between 20 seconds and 30 seconds after the onset of oxidation. The onset of oxidation may be monitored in real time to determine the point at which the carbonaceous material should be cooled. Onset of oxidation may easily be determined in real time by using a DSC-TG type apparatus and monitoring the temperature of the carbonaceous material compared with a known reference material. Alternatively, the appropriate conditions for the onset of oxidation may be determined in advance and the carbonaceous material cooled after a predetermined time of thermal treatment or after a predetermined temperature has been achieved.

The temperature range over which oxidation is preferred for any given conditions may be termed an oxidation window. An oxidation window for a batch of nano-structured carbonaceous material under specific conditions may be defined by a lower and an upper temperature. Nano-structured carbonaceous material may oxidise with a lower onset of oxidation temperature than diamond. The preferred oxidation window may therefore be defined over a temperature range within which oxidation of the nano-structured carbonaceous material occurs but oxidation of diamond does not, or within which the oxidation of diamond is not kinetically favourable. Thus, within such a preferred window a diamond structure may be relatively more stable than the non-diamond structure of the nano-structured carbonaceous material. If sp^{a} bonds are present, oxidation within such a window may favour nucleation and growth of diamond.

The upper and lower temperatures of an oxidation window within which oxidation of the nano-structured carbonaceous material occurs but oxidation of diamond does not may be influenced by the presence of a catalyst. Thus, the presence of an alkali metal carbonate, such as lithium carbonate, may lower the temperature at which oxidation of a nano-structured carbonaceous material occurs. The wider the temperature range of the oxidation window the easier it may be to retain the nano-structured carbonaceous material within an environment within which nucleation and growth of diamonds is favoured.

In some embodiments it may be preferred that the nano-structured carbonaceous material is thermally treated at a relatively high temperature in order to improve the kinetics of diamond growth. In such embodiments it may be desirable to carry out the thermal treatment in a low oxygen atmosphere in order to increase the oxidation onset temperature. It is preferred that oxidation is carried out in presence of a catalyst in order to provide a window between the oxidation onset temperature of the nano-structured carbonaceous material and the oxidation onset of diamond.

It may be particularly preferable that the nano-structured carbonaceous material is quenched rapidly after having undergone the desired heat treatment. For example, it may be preferable to heat the nano-structured carbonaceous material in an oxygen-containing atmosphere, for example air, at a predetermined heating rate to a maximum temperature of between 400 and 700° C., at which oxidation occurs. Once the carbonaceous nanostructures reach the predetermined temperature they may be rapidly quenched, for example using a stream of air at ambient temperature. Alternatively, the nano-structured carbonaceous material may be placed in an environment that has been pre-heated to a predetermined temperature, for example a temperature of between 400 and 1300° C., for a predetermined period of time, for example 10 minutes, and then rapidly cooled to ambient temperature.

Cooling may occur by quenching in a stream of gas. Preferably the cooling rate is is greater than 25° C., for example greater than 100° C. per minute, or greater than 500° C. per minute. It is noted that cooling need not be linear with time and the actual cooling rate may vary during cooling.

In a further aspect, a method of producing diamonds may comprise the steps of providing a nano-structured carbonaceous material, and thermally treating the nano-structured carbonaceous material in the presence of a catalyst comprising an alkali metal species. The catalyst may be any catalyst as described above in relation to the first aspect of the invention. For example, a preferred catalyst may be nano-scale particles of lithium carbonate. The step of thermally-treating the nano-structured carbonaceous material may be any thermal treatment step as described above with respect to the first aspect of the invention.

The method of the further aspect may comprise holding the nano-structured carbonaceous material at a temperature at which oxidation of the nano-structured carbonaceous material is more favourable than oxidation of diamond. The atmosphere surrounding the nano-structured carbonaceous material need not contain oxygen if the nano-structured carbonaceous material would react with the catalyst to undergo an oxidation. For example, at the appropriate temperature lithium carbonate may react with nano-structured carbonaceous material in an oxidation reaction that produces diamonds and carbon dioxide and lithium.

In a preferred embodiment according to one or more aspects of the invention described above, nano-structured carbonaceous material, for example nanotubes and nanoparticles, are formed by the electrochemical erosion of graphite via the electrolysis of molten LiCl with graphite electrodes. When such carbon nanostructures are oxidised in air at ambient pressure at a temperature of between 400 and 700° C., they transform, very surprisingly, into a mixture of diamonds and nano-sized graphite-type carbon particles.

A preferred embodiment of a method for producing diamonds may thus comprise two stages. In a first stage, nano-structured carbon material containing encapsulated lithium carbonate (Li₂CO₃) nanocrystals may be produced by electrochemical erosion of graphite in a molten salt. For example, the first step may involve the electrochemical erosion of graphite via the electrolysis of molten LiCl with graphite electrodes, which leads to the production of a nano-structured carbon material. Typical conditions of temperature and geometric current density during electrolysis are 650 to 1200° C. and 0.5 to 3.0 A cm⁻², respectively. In a second stage, diamond crystals are produced by thermal treatment of this nano-structured carbon material in air, preferably at ambient pressure. The diamond crystals may have a diameter of between 0.05 μm and 10 μm, for example diamond crystals having a diameter of the order of between 0.1 μm and 2 μm or 0.5 to 1 μm. The diameter of any diamond crystal may be any diameter as disclosed above. The heat treatment may result in the formation of a mixture of pyramid-shaped (octahedral) diamond crystals and nano-sized graphite-type carbon particles. Typical conditions during this oxidative heat-treatment are an atmosphere of ambient air and heating to a temperature of 400 to 700° C., for example about 500° C. plus or minus about 40° C., followed by a rapid quench to ambient temperature.

In a further aspect, a powder may comprise a mixture of nano-structured carbonaceous material, such as nano-tubes, nano-particles, or nano-scrolls, and crystals of diamond, the diamond crystals being between 0.1 micrometre and 10 micrometres in diameter. For example, the diamond crystals may be between 0.5 micrometre and 2 micrometres in diameter.

Preferred and advantageous embodiments of the invention may be set out in the following numbered clauses.

Clause 1. A method of producing diamonds comprising the steps of, providing a nano-structured carbonaceous material, and thermally treating the nano-structured carbonaceous material in an oxygen-containing environment so as to produce diamonds.

Clause 2. A method according to clause 1 in which the nano-structured carbonaceous material comprises one or more nano-structures selected from the list consisting of carbon nano-particles, carbon nano-tubes and carbon nano-scrolls.

Clause 3. A method according to clause 1 or 2 in which the nano-structured carbonaceous material is in contact with a catalyst when thermally treated.

Clause 4. A method according to clause 3 in which the catalyst comprises an alkali metal.

Clause 5. A method according to clause 3 or 4 in which the catalyst comprises an alkali metal salt, for example a salt of lithium or a salt of sodium.

Clause 6. A method according to clauses 3, 4, or 5 in which the catalyst is an alkali metal carbonate, for example lithium carbonate or sodium carbonate.

Clause 7. A method according to any of clauses 3 to 6 in which at least a portion of the catalyst is disposed within the nano-structured carbonaceous material, for example within internal cavities of nano-particles, nano-tubes and/or nano-scrolls.

Clause 8. A method according to any of clauses 3 to 7 in which the catalyst is present in the form of nanoscale particles disposed on or within the nano-structured carbonaceous material.

Clause 9. A method according to clause 8 in which the catalyst is present in the form of particles or deposits having dimensions of between 1 and 10 nanometres.

Clause 10. A method according to any preceding clause in which a catalyst is added to the nano-structured carbonaceous material prior to, or during, the step of thermally treating.

Clause 11. A method according to any of clauses 1 to 9 in which a catalyst is incorporated in the nano-structured carbonaceous material during formation of the nano-structured carbonaceous material.

Clause 12. A method according to any preceding clause in which the nano-structured carbonaceous material is created by electrochemical erosion of graphite in a molten salt.

Clause 13. A method according to clause 12 in which the molten salt is a lithium-bearing molten salt, or a sodium-bearing molten salt.

Clause 14. A method according to clause 12 or 13 in which the nanostructured carbonaceous material is created by the intercalation of lithium or sodium into graphite.

Clause 15. A method according to any preceding clause in which the nano-structured carbonaceous material is created at temperatures between 650 and 1200° C.

Clause 16. A method according to any preceding clause in which the nano-structured carbonaceous material is created using geometric cathodic densities between 0.5 and 3 A cm⁻².

Clause 17. A method according to any preceding clause in which the step of thermally treating the nano-structured carbonaceous material is carried out at a pressure lower than 1000 kPa, preferably lower than 200 kPa, for example at about 100 kPa.

Clause 18. A method according to any preceding clause in which the step of thermally treating the nano-structured carbonaceous material is carried out at ambient atmospheric pressure.

Clause 19. A method according to any preceding clause in which the step of thermally treating the nano-structured carbonaceous material is carried out in an environment having a minimum oxygen content of 0.1 volume % oxygen, for example greater than 1 volume % oxygen.

Clause 20. A method according to clause 19 in which the step of thermally treating the nano-structured carbonaceous material is carried out in air.

Clause 21. A method according to clause 19 or 20 in which the environment has an oxygen content of greater than 10% by volume and the nano-structured carbonaceous material is thermally treated such that the maximum temperature of the oxygen-containing environment surrounding the nano-structured carbonaceous material is between 400 and 700° C., for example between 500 and 650° C.

Clause 22. A method according to clause 19 or 20 in which the environment has an oxygen content of lower than 10% by volume and the nano-structured carbonaceous material is thermally treated such that the maximum temperature of the oxygen-containing environment surrounding the nano-structured carbonaceous material is between 400 and 1300° C., for example between 500 and 1000° C.

Clause 23. A method according to any preceding claim in which thermal treatment includes holding the nano-structured carbonaceous material isothermally at a predetermined temperature for a predetermined period of time.

Clause 24. A method according to any preceding clause in which the step of thermally treating the nano-structured carbonaceous material involves heating the nano-structured carbonaceous material, or the oxygen-containing environment surrounding the nano-structured carbonaceous material, to a predetermined maximum temperature at a heating rate of between 1 and 150° C. min⁻¹ and then rapidly cooling.

Clause 25. A method according to clause 24 in which the heating rate is between 20 and 150° C. min⁻¹, for example between 60 and 120° C. min⁻¹, for example between 80 and 100° C. min⁻¹.

Clause 26. A method according to any of clauses 1 to 24 in which the nano-structured carbonaceous material is thermally treated by introducing the nano-structured carbonaceous material into an oxygen-containing environment that has been pre-heated to a temperature of between 400 and 1300° C., for example between 500 and 1000° C., or between 550 and 700° C.

Clause 27. A method according to any of clauses 24 to 26 in which the predetermined maximum temperature is maintained for a period of less than 10 minutes before the nano-structured carbonaceous material is cooled.

Clause 28. A method according to any of clauses 24 to 26 in which cooling of the nano-structured carbonaceous material is initiated when the predetermined maximum temperature is reached.

Clause 29. A method according to any of clauses 1 to 23 in which the onset of oxidation of the nano-structured carbonaceous material is determined, and, during thermal treatment, the nano-structured carbonaceous material is cooled a predetermined time after the onset of oxidation.

Clause 30. A method according to clause 29 in which the predetermined time after the onset of oxidation is between 5 seconds and 10 minutes, for example between 20 seconds and sixty seconds, for example between 30 seconds and 40 seconds.

Clause 31. A method according to clause 29 or 31 in which the onset of oxidation is monitored in real time during thermal treatment, for example by using a thermocouple and a reference material.

Clause 32. A method according to any of clauses 27 to 31 in which the cooling rate is greater than 25° C. min⁻¹ , for example greater than 100° C. min⁻¹.

Clause 33. A method according to any of clauses 24 to 32 in which the nano-structured carbonaceous material is quenched from the maximum temperature at a rate of greater than 500° C. min⁻¹.

Clause 34. A method of producing diamonds comprising the steps of, providing a nano-structured carbonaceous material, and thermally treating the nano-structured carbonaceous material in the presence of a catalyst comprising an alkali metal species.

Clause 35. A method according to clause 34 in which the catalyst comprises a salt of lithium or a salt of sodium.

Clause 36. A method according to clauses 34 or 35 in which the catalyst is lithium carbonate or sodium carbonate.

Clause 37. A method according to any of clauses 34 to 36 in which at least a portion of the catalyst is disposed within internal cavities of the nano-structured carbonaceous material, for example within internal cavities of nano-particles, nano-tubes and/or nano-scrolls.

Clause 38. A method according to any of clauses 34 to 38 in which the catalyst is present in the form of nanoscale particles disposed on or within the nano-structured carbonaceous material.

Clause 39. A method according to clause 38 in which the catalyst is present in the form of particles having dimensions of between 1 and 10 nanometres.

Clause 40. A method according to any of clauses 34 to 39 in which a catalyst is added to the nano-structured carbonaceous material prior to or during the thermal treating step.

Clause 41. A method according to any of clauses 34 to 39 in which a catalyst is incorporated in the nano-structured carbonaceous material during formation of the nano-structured carbonaceous material.

Clause 42. A method according to any of clauses 34 to 41 in which the nano-structured carbonaceous material is created by electrochemical erosion of graphite in a molten salt.

Clause 43. A method according to clause 42 in which the molten salt is a lithium-bearing molten salt, or a sodium-bearing molten salt.

Clause 44. A method according to clause 42 or 43 in which the nanostructured carbonaceous material is created by the intercalation of lithium or sodium into graphite.

Clause 45. A method according to any of clauses 34 to 44 in which the nano-structured carbonaceous material is created at temperatures between 650° C. and 1200° C.

Clause 46. A method according to any of clauses 34 to 45 in which the nano-structured carbonaceous material is created using geometric cathodic densities between 0.5 and 3 A cm⁻².

Clause 47. A method according to any of clauses 34 to 46 in which the step of thermally treating occurs at a pressure lower than 1000 kPa, preferably lower than 200 kPa, for example at about 100 kPa, preferably at ambient atmospheric pressure.

Clause 48. A method according to any of clauses 34 to 47 in which the onset of oxidation of the nano-structured carbonaceous material is determined, and, during thermal treatment, the nano-structured carbonaceous material is cooled a predetermined time after the onset of oxidation.

Clause 49. A method according to clause 48 in which the predetermined time after the onset of oxidation is between 5 seconds and 10 minutes, for example between 20 seconds and sixty seconds, for example between 30 seconds and 40 seconds.

Clause 50. A method according to clause 48 or 49 in which the onset of oxidation is monitored in real time during thermal treatment, for example by using a thermocouple and a reference material.

Clause 51. A method according to any of clauses 34 to 54 in which the catalyst comprises oxygen and the thermal treatment to form diamonds occurs in an inert environment or a vacuum.

Clause 52. A method according to any preceding clause in which the nano-structured carbonaceous material is thermally-treated under conditions in which oxidation of the nano-structured carbonaceous material is more energetically or kinetically favourable than oxidation of diamond.

Clause 53. A method according to clause 51 in which the nano-structured carbonaceous material is thermally-treated in air at atmospheric pressure and in the presence of an alkali metal carbonate catalyst, thermal-treatment involving heating the nano-structured carbonaceous material to a temperature of between 400° C. and 600° C.

Clause 54. A method according to clause 51 in which the nano-structured carbonaceous material is thermally-treated in a low oxygen environment, having an oxygen content of less than 10 volume %, thermal-treatment involving heating the nano-structured carbonaceous material to a temperature greater than 600° C.

Clause 55. A method according to any preceding clause in which the nano-structured carbonaceous material undergoes a pre-treatment in which it is heated to a temperature of greater than 1000° C. in a reducing atmosphere prior to being thermally treated to form diamonds.

Clause 56. A diamond produced by a method according to any preceding clause.

Clause 57. A powder comprising a mixture of nano-structured carbonaceous material and diamonds, in which the diamonds are between 0.05 micrometre and 100 micrometre in diameter, for example between 0.1 micrometre and 10 micrometre, or 0.2 micrometre and 5 micrometre.

Clause 58. A powder according to clause 57 in which the nano-structured carbonaceous material is one or more nano-structured carbonaceous particle selected from the list consisting of carbon nano-particles, carbon nano-tubes and carbon-nanoscrolls.

Clause 59. A powder according to clause 57 or 58 in which more than half, or most, or substantially all of the diamond crystals are shaped as regular octahedrons.

Clause 60. A methods substantially as defined herein, and with reference to the figures.

Clause 61. Diamonds substantially as described herein and with reference to the figures.

Clause 62. A powder substantially as described herein and with reference to the figures.

### SPECIFIC EMBODIMENTS

Specific embodiments exemplifying the invention will be described below with reference to the appended figures, in which;

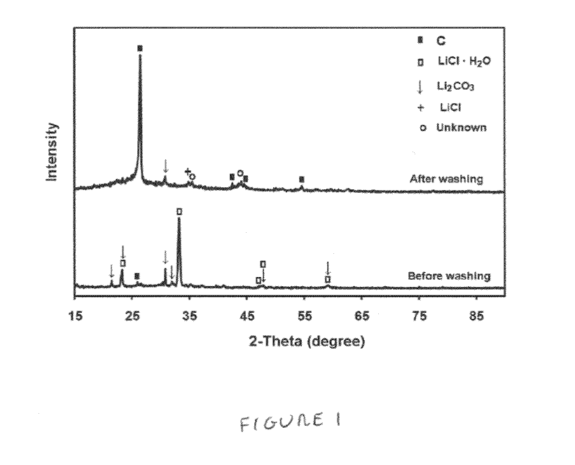

FIG. 1 shows an x-ray diffraction (XRD) spectra of electrolytically produced carbon material taken before and after washing,

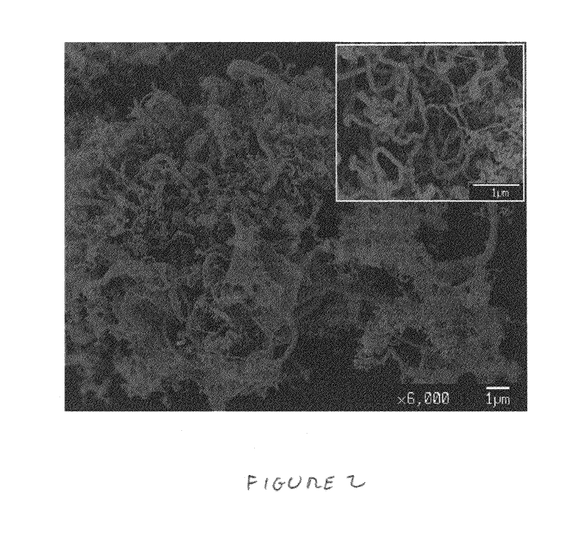

FIG. 2 shows an Scanning Electron Microscope (SEM) micrograph of electrolytically produced carbon after washing and drying,

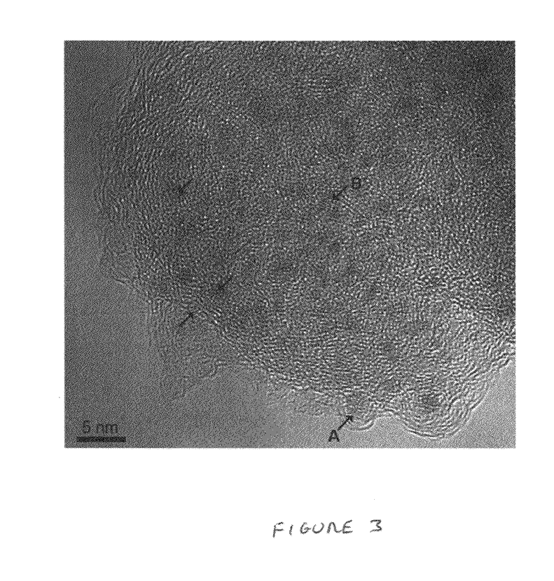

FIG. 3 shows a high-resolution transmission electron microscope (HRTEM) micrograph of electrolytically produced carbon after washing and drying,

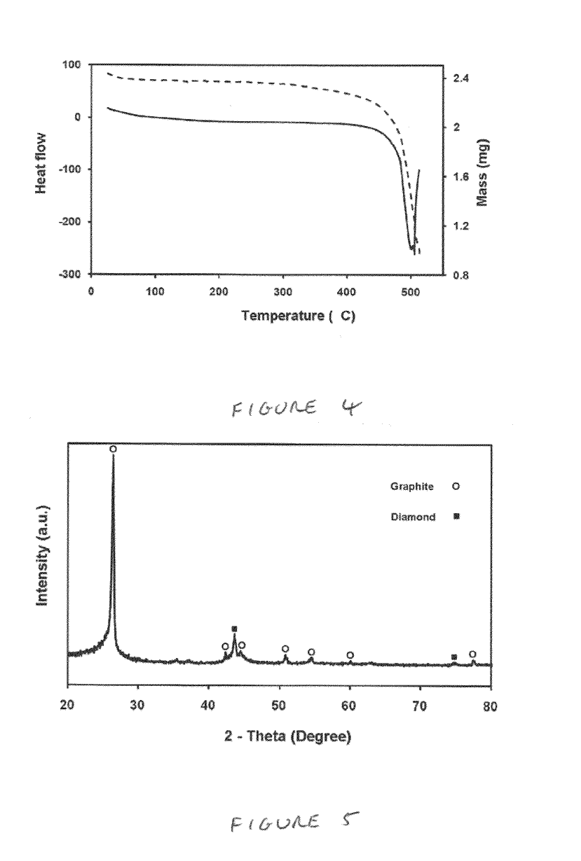

FIG. 4 shows a differential scanning calorimetry-thermogravimetric analysis (DSC-TG) curve of electrolytically produced carbon material during thermal treatment,

FIG. 5 shows an XRD spectra of electrolytically produced carbon material after thermal treatment,

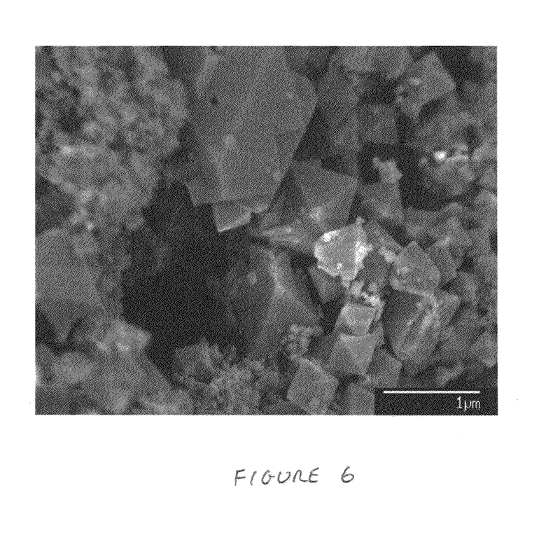

FIG. 6 is a SEM micrograph of electrolytically produced carbon material after thermal treatment, showing diamonds formed by the thermal treatment,

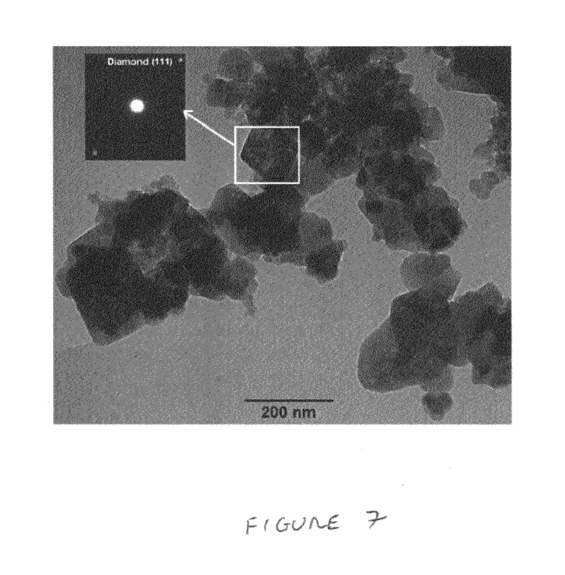

FIG. 7 is a TEM micrograph of electrolytically produced carbon material after thermal treatment,

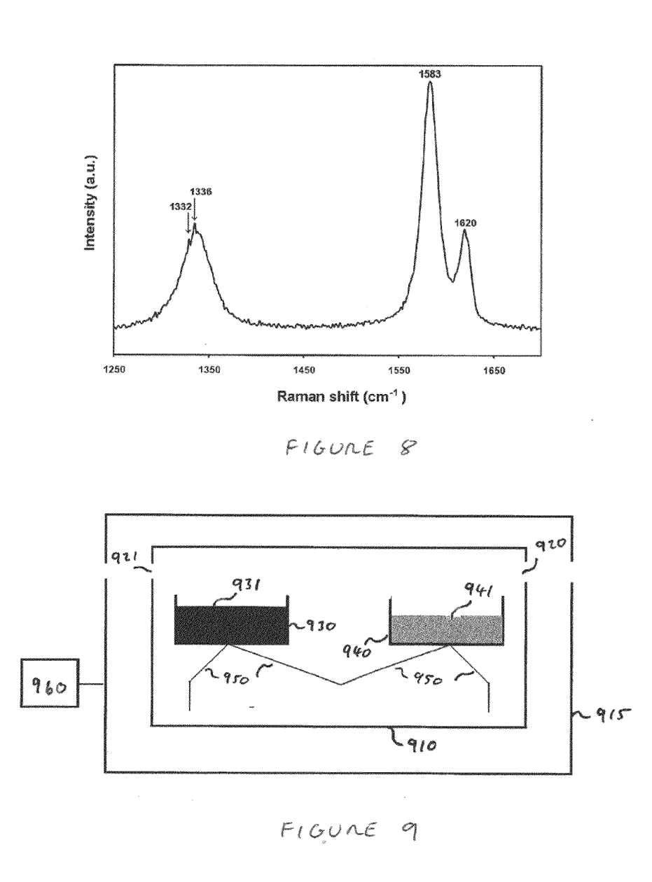

FIG. 8 shows a Raman spectrum of electrolytically produced carbon material after thermal treatment,

FIG. 9 is a schematic diagram illustrating an apparatus that may be used to implement a method according to an embodiment of the invention,

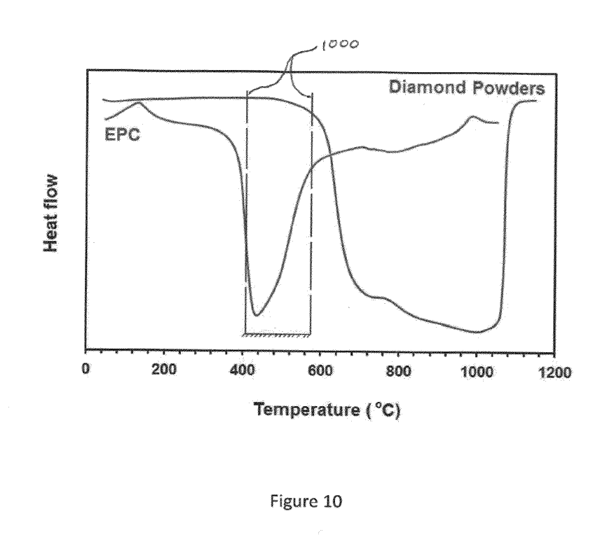

FIG. 10 shows a comparison of DSC curves between an electrochemically-produced carbon (EPC) powder and a diamond powder illustrating a temperature window within which the EPC powder is unstable but diamond is relatively more stable.

### ELECTROCHEMICCALY-PRODUCED CARBON (EPC) Powder

The following describes production of an EPC for use as a nano-structured carbonaceous material for the production of diamonds.

Approximately 200 g of anhydrous LiCl (213233, Sigma-Aldrich) was placed in a graphite crucible of inner diameter 55 mm and height 130 mm. This was heated to a target temperature of 650-1200° C. under an atmosphere of argon. The argon was dried prior to use by passing it over self-indicating CaSO₄.

Electrolysis of the molten LiCl was performed with a graphite rod serving as the cathode and the graphite crucible serving as the anode. The cathode rod had a diameter of 6.5 mm, and was shielded tightly by an alumina tube so that a length of 1 cm at its lower end was exposed to the melt. Electrolysis was performed with a constant current of 4.7 A, corresponding to an initial geometric current density at the cathode of about 2.0 A cm⁻², and for the duration of 10 min.

Without wanting to be bound to theory, it is assumed that during the molten salt electrolysis with graphite electrodes, there is an excessive accumulation of lithium species into the spaces between the graphene layers of the graphite structure, which exerts mechanical stress onto the graphite matrix, causing its erosion and the expellation of nano-structured carbon constituents from the graphite cathode into the molten salt. It may be the case that a fraction of carbon atoms in EPC form sp³ bond due to the curvature and defects of nanostructured carbon material. It may be that sp³ content of EPC is promoted by the intercalation of lithium species taking place during the molten salt electrolysis process. The presence of sp³ bonds may positively influence the nucleation and growth of diamond during subsequent thermal treatment of the nano-structured carbon material.

After electrolysis the cell was cooled to room temperature. The nano-structured carbon material produced by the electrolysis was recovered and rinsed with copious amounts of distilled water in order to remove lithium chloride, and the resulting suspension was then vacuum-filtered to separate the carbon product. The latter was collected and dried at 100° C. in a vacuum of 0.1 mbar for 6 h.

A Philips 1710 high resolution X-ray diffractometer (XRD) with Cu anode was used for phase analysis of the carbon materials occurring at the various stages of the experiments. A JEOL 6340F field emission scanning electron microscope (SEM), a JEOL 2000FX analytical transmission electron microscope (TEM), and JEOL 4000 EX-II high resolution TEM (HRTEM) were used for microstructural investigations. A Renishaw 1000 Ramascope with a He-Ne ion laser of wavelength 633 nm was used for micro-Raman spectroscopy.

The XRD spectrum of the post-electrolysis material taken before the washing and drying treatment (FIG. 1) shows the presence of LiCl.H₂O, Li₂CO₃ and carbon of graphitic structure. LiCl.H₂O is present because LiCl crystals easily absorb water from the atmosphere to form a hydrate. Li₂CO₃ can form through the reaction of intercalated lithium with carbon in the presence of oxygen donor materials such as impurities and binders present in the graphite bulk or residual air contained in the graphite pores. The XRD spectrum of the carbon product obtained after washing and drying (FIG. 1) indicates the effective removal of the LiCl from the raw product. However, a considerable amount of Li₂CO₃ is left after the treatment. This can be explained by the different solubilities of LiCl and Li₂CO₃ in water which are 83.2 and 13.2 g l⁻¹ at 20° C., respectively. The unknown peaks in the XRD spectrum may be attributed to small quantities of lithium-containing constituents that are formed as by-products.

Carbon of graphitic structure is identified in the electrolytically produced carbon material by its characteristic XRD peaks. The crystalline domain size of the carbon material along the c-axis was calculated by quantitatively evaluating the hexagonal (002) peak at 2θ=26.50° using Scherrer's formalism and found to be 41 nm. The result proves the formation of nano-crystalline graphite-type carbon.

The microstructure of the electrolytically produced carbon material was analysed by SEM (FIG. 2) and found to comprise tubes with diameters in the wide range of 10 to 500 nm and spherical nanoparticles with diameters of typically less than 100 nm. Some graphitic sheets were also seen. TEM analysis was used for high-resolution analysis, and a selected area of the carbon product (FIG. 3) shows the presence of encapsulated single nanocrystals of lithium carbonate (Li₂CO₃) with diameters of 1 to 3 nm surrounded by graphitic shells. In other words, the nanocrystals of lithium carbonate are disposed within carbon nano-structures.

The above results suggest that the electrolytically produced carbon material contains crystals of lithium carbonate located inside the spacings of the graphitic layers. Lithium carbonate is a material that may act as a catalyst for the conversion of graphitic carbon to diamond. For example, lithium carbonate may lower the oxidation onset temperature of the nano-structured carbon material, thereby creating a window within which nano-structured carbon material oxidises but diamond is relatively stable. FIG. 10 shows a comparison of DSC curves between an electrochemically-produced carbon (ECP) powder and a diamond powder illustrating a temperature window 1000 within which the ECP powder is unstable but diamond is relatively more stable.

Material of this type, i.e. comprising nano-structured carbonaceous structures having particles of lithium carbonate disposed internally within the structures, was then subjected to heat-treatment in air as described below.

Production of Diamonds by Thermal Treatment of EPC Powder

An SDT Q600 analyser equipped with alumina crucibles was used for heat treatment experiments on the carbon product. In each experiment about 2.5 mg of carbon product (i.e. the nanostructured carbon material produced by the electrolysis step described above) was heated to different temperatures in an atmosphere of air followed by quenching in a flow of ambient air. Differential Scanning calorimetry (DSC) and Thermogravimetric Analysis (TG) were performed during each experiment. Once a desired temperature was reached for each experiment, the carbon product was rapidly quenched using a stream of ambient air.

DSC and TG analyses of the electrolytically produced carbon material (FIG. 4) indicate that it is oxidised at temperatures between 440 and 535° C. with a peak at 510° C. when heated in ambient air of flow rate 100 ml min⁻¹ at a heating rate of 80° C. min⁻¹.

When heating at a rate of 80° C. per minute, it takes a total of about 7 minutes to heat a sample of carbon product to a target temperature of about 515° C. before cooling to room temperature. Of these 7 minutes, the carbon product may be in an oxidising regime for less than 1 minute.

An XRD spectrum of the heat-treated carbon material (FIG. 5) shows that the peaks of graphite are observed in the whole range investigated. In particular, the peak at 20=26.43° is that of the (002) lattice planes of graphite. Very surprisingly, the peaks at 20=43.66° and 74.80° are those of the (111) and (220) lattice planes of diamond, respectively.

An SEM micrograph of the heat-treated carbon material (FIG. 6) shows the presence of square-based pyramid, or octahedral shaped crystals mixed with carbon nanoparticles. This is further confirmed by the TEM micrograph (FIG. 7).

Each edge of the pyramids' square bases has a length between approximately 0.1 and 2 μm. The selected area electron diffraction (ED) pattern recorded on a diamond crystal is shown as inset in FIG. 7 The spots in the ED pattern can be indexed as (111) planes of cubic diamond with a d-value of 2.05 Å

A Raman spectrum of the heat-treated carbon material (FIG. 8) exhibits the main features associated with sp^{a} and sp² carbon. A broad band is seen in the range of 1300 to 1380 cm⁻¹ with two well resolved peaks included therein. The characteristic peak at 1332 cm⁻¹ originates from the first-order lattice vibration of diamond. The peak at 1336 cm⁻¹ is the disorder-induced D line of graphite which indicates the presence of nano-crystalline graphite. It is noted that the position of the D band is shifted downward from the typical range of 1360 to 1336 cm⁻¹ which may be attributed to the occurrence of sp^{a}-bonded carbon atoms in the structure of the heat-treated material. The peak at 1583 cm⁻¹ is the characteristic G line of graphitic carbon, and the peak at 1620 cm⁻¹ is the characteristic D′ line of graphitic carbon. Overall, the Raman spectrum contains bands from both diamond and graphite-type carbon constituents.

In summary, the XRD, SEM, TEM, ED and Raman analyses of the heat-treated carbon material unambiguously prove that it comprises a mixture of diamonds and graphite-type nanoparticles.

Demonstration of Differential Oxygen Onset Temperatures between EPC Powder and Diamond Powder

FIG. 10 compares the DSC curve of an EPC powder with that of diamond powders. The EPC powder is that described above and includes a proportion of lithium carbonate, which acts to reduce the oxidation onset temperature of the EPC.

The curve illustrated in FIG. 10 demonstrates that there is a temperature/time gap or window 1000 between the oxidation of EPC and oxidation of diamond. It means that during the heating of EPC, a region is reached within which graphitic carbon nanomaterials are unstable due to oxidation but diamond powders are relatively more stable. Within this region, the nucleation and growth of sp^{a}-bonded domains from carbon nanomaterials is thermodynamically possible. The formation of diamonds from nanostructured carbonaceous material is kinetically most favourable at the higher end of this region. Thus, it may be desirable to carry out a thermal treatment of a nanostructured carbonaceous material at the highest temperature at which the nanostructured carbonaceous material is unstable but diamond is relatively more stable.

Production of Diamonds by Isothermal Treatment of EPC Powder

Hybrid ramp-isothermal experiments were carried out on an EPC powder. In this example, a heating ramp of 40° C. min⁻¹ wasconducted up to a temperature of 500° C., followed by an isothermal heating step in which temperature was kept unchanged at 500° C. for a period of 10 min. The temperature of 500° C. is lower than the oxidation peak temperature obtained from the same powder under ramped heating condition (552° C.). However, it was noted from DSC analysis that an oxidation peak still occurred during isothermal heating of the material at 500° C. A ramp-isothermal heating regime may allow the EPC powder to be maintained for longer periods of time at high temperatures. This may advantageously promote growth of diamonds.

After the isothermal holding period, the material was cooled rapidly to room temperature. An SEM investigation of the heat treated material revealed the presence of diamond crystals.

Apparatus for the Production of Diamonds from Nano-Structured Carbon Powder

On the experimental scale, thermal treatment of nanostructured carbonaceous material to form diamonds has taken place using DSC apparatus. Such apparatus conveniently allows a wide range of thermal conditions to be applied to the sample and advantageously allows monitoring of the onset of oxidation in the carbonaceous material. FIG. 9 is a schematic illustration of an apparatus, based on DSC principles, that may be used to form diamonds on an industrial scale.

The apparatus of FIG. 9 comprises an electrically heated furnace 910 located within an insulating housing 915. The furnace could be heated by any other suitable means, for example by gas-burners. The furnace includes a gas inlet 920 and a gas outlet 921, for the passage of gas into and out of the furnace. The furnace contains two pans, a first pan 930 for holding a feedstock of nanostructured carbonaceous material 931, and a second pan 940 for holding a reference material 941, for example Al₂O₃. Thermocouples 950 are coupled to the base of each pan and record the difference in temperature between the sample and the reference material. This can be used to determine the onset of oxidation of the sample. A controller 960 is used to control heating and cooling of the furnace and accepts input from the thermocouples 950.

In use, a suitable feedstock of nanostructured carbonaceous material 931 is loaded into the first pan 930. A suitable material 931 may be a nanostructured carbonaceous material comprising nanotubes, formed by electrolysis in a lithium based molten salt, the carbonaceous material further comprising lithium carbonate. The atmosphere within the furnace is that of ambient air, and the pressure within the furnace is ambient atmospheric pressure. The temperature of the furnace would then be raised at a suitable heating rate, for example 80° C. min⁻¹, and the reaction of the feedstock 931 would be monitored. At a predetermined time after the onset of oxidation, for example 20 seconds or 30 seconds after the onset of oxidation, the controller 960 initiates quenching of the feedstock in a stream of air. Diamonds formed in the thermally treated feedstock may then be recovered.

It is clear that an apparatus for production of diamonds on a commercial scale need not involve the monitoring of the oxidation point. The parameters for diamond production, such as heating rate, temperature and time, may be easily determined by experimentation. Thus, the apparatus required may simply consist of a suitable furnace with the ability to quench a feedstock after a predetermined time.

The apparatus described above would produce diamonds as a batch process. A commercial apparatus may allow the production of diamonds as a continuous process in which a feedstock is constantly fed into one end of the apparatus and thermally treated feedstock, comprising diamonds, is constantly output.

1-62. (canceled)

63. A method of producing diamonds comprising the steps of, providing a nano-structured carbonaceous material, and thermally treating the nano-structured carbonaceous material in an oxygen-containing environment in the presence of a catalyst comprising an alkali metal so as to produce diamonds

64. A :method according to claim 63 in which the nano-structured carbonaceous material comprises one or more nano-structures selected from the list consisting of carbon nano-particles, carbon nano-tubes, carbon nano-scrolls, nano-filaments and nano-onions, full crone based carbon particles and nano-scale graphene-based particles.

65. A method according to claim 63 in which the catalyst comprises an alkali metal salt.

66. A method according to claim 63 in which the catalyst is an alkali metal carbonate.

67. A method according to claim 63 in which the catalyst is present in the form of nanoscale particles disposed. on or within the nano-structured carbonaceous material, wherein the particles have dimensions of between 1 and 10 nanometres.

68. A method according to claim 63 in which the nano-structured carbonaceous material is created by electrochemical erosion of graphite in a molten salt.

69. A method according to claim 68 in which the molten salt is a lithium-bearing molten salt, or a sodium-bearing molten salt.

70. A method according to claim 68 in which the nano-structured carbonaceous material is created by the intercalation of lithium or sodium into graphite

71. A method according to claim 63 in which the nano-structu red carbonaceous material is created at temperatures between 650 and 1200° C.

72. A method according to claim 63 in which the nano-structured carbonaceous material is created using geometric cathodic densities between 0.5 and 3 A cm⁻².

73. A method according to claim 63 in which the step of thermally treating the nano-structured carbonaceous material is carried out at a pressure lower than 1000 kPa, preferably lower than 200 kPa.

74. A method according to claim 63 in which the step of thermally treating the nano-structured carbonaceous material is carried out in an environment having a minimum oxygen content of 0.1 volume % oxygen

75. A method according to claim 74 in which the step of thermally treating the nano-structured carbonaceous material is carried out in air.

76. A method according to claim 74 in which the environment has an oxygen content of lower than 10% by volume and the nano-structured carbonaceous material is thermally treated such that the maximum temperature of the oxygen-containing environment surrounding the nano-structured carbonaceous material is between 400 and 1300° C.

77. A method according to claim 63 in which the thermal treatment includes holding the nano-structured carbonaceous material isothermally at a predetermined temperature for a period of time between 5 seconds and 10 minutes, wherein the predetermined temperature is the temperature at which the nano-structured carbon starts to oxidise.

78. A method according to claim 63 in which the step of thermally treating the nano-structured carbonaceous material involves heating the nano-structured carbonaceous material, or the oxygen-containing, environment surrounding the nano-structured carbonaceous material, to a predetermined maximum temperature at a heating rate of between 1 and 150°C. min⁻¹ and then rapidly cooling.

79. A method according to claim 63 in which the nano-structured carbonaceous material is thermally treated by introducing the nano-structured carbonaceous material into an oxygen-containing environment that has been pre-heated to a temperature of between 400 and 1300° C.

80. A method according to claim 78 in which the predetermined maximum temperature is maintained for a period of less than 10 minutes before the nano-structured carbonaceous material is cooled.

81. A method according to claim 63 in which the method includes a step of determining the onset of oxidation of the nano-structured carbonaceous material, and, during thermal treatment, the nano-structured carbonaceous material is cooled a predetermined time after the onset of oxidation, wherein the predetermined time after the onset of oxidation is between 5 seconds and 10 minutes

82. A method according to claim 81 in which the onset of oxidation is monitored in real time during thermal treatment, for example by using a thermocouple and a reference material.

83. A method according to claim 80 in which the cooling rate is greater than 100° C. min⁻¹.

84. A method according to claim 63 in which the catalyst comprises oxygen and the thermal treatment to form diamonds occurs in an inert environment or a vacuum.

85. A method according to claim 84 in which the nano-structured carbonaceous material is thermally-treated in air at atmospheric pressure and in the presence of an alkali metal carbonate catalyst, thermal-treatment involving heating the nano-structured carbonaceous material to a temperature of between 400° C. and 600° C.

86. A method according to claim 84 in which the nano-structured carbonaceous material is thermally-treated in a low oxygen environment, having an oxygen content of less than 10 volume thermal-treatment involving heating the nano-structured carbonaceous material to a temperature greater than 600° C.

87. A method according to claim 63 in which the nano-stnictured carbonaceous material undergoes a pre-treatment in which it is heated to a temperature of greater than 1000° C. in a reducing atmosphere prior to being thermally treated to form diamonds.
